(19) United States
(12) Patent Application Publication
(10) Pub. No.: US 2023/0379333 A1
(43) Pub. Date: Nov. 23, 2023

(54) EMERGENCY CONTACT NOTIFICATION SYSTEM

(71) Applicant: ARRIS Enterprises LLC, Suwanee, GA (US)

(72) Inventors: Christopher R. BOYD, Chalfont, PA (US); Christopher S. DEL SORDO, Souderton, PA (US); Mallika SUBRAMANYAM, Warrington, PA (US)

(21) Appl. No.: 18/142,156

(22) Filed: May 2, 2023

Related U.S. Application Data
(60) Provisional application No. 63/343,588, filed on May 19, 2022.

(51) Int. Cl. H04L 9/40

(52) U.S. Cl. CPC H04L 63/102; H04L 63/104

(57) ABSTRACT

To provide a primary use with the required authorized services, a user information interface system (UIIS) provides authorization to send a user profile associated with the primary user to one or more types of users. The UIIS can receive a request from a user for access to a user profile. The request can comprise authorization information received from a network device associated with the primary user. The UIIS can verify that a user has access to the user profile based on one or more access parameters associated with the user profile. The UIIS can automatically send a notification to one or more users as indicated by the user profile and can update the one or more users throughout a treatment process associated with the primary user.

### BACKGROUND

Generally, first responders or others that provide one or more emergency services are the first persons at an emergency or otherwise time-sensitive event. Valuable time can be lost at such an event due to an inability to determine an identity of a user that is in need of one or more services or the inability to determine an identification of an emergency contact. Even if such identification is determined, it can be difficult to actually contact the emergency contact or even to obtain information associated with the identity of the user. Rather than focusing on the well-being of the user, time is lost with such determinations. A streamlined process is needed to make identification and notification easier, faster and more reliable.

### SUMMARY

Generally, it is difficult to keep one or more contacts associated with a person in distress or otherwise in need of care updated with notifications of status or even whereabouts of the person. Authorized services personnel (for example, any of healthcare professionals, a first responder, a paramedic, a caregiver, or any combination thereof), such as personnel that provide one or more emergency services, must make quick decisions while in a very stressful environment. Administration of one or more services or care to a user, for example, a user requiring emergency medical services, can be hindered by the lack of information associated with the identity of the user, the identity of an emergency contact, or both. Critical treatment can be delayed as precious time is wasted by the authorized services personal trying to determine information about the user, an authorized contact, or both. To streamline such a process, a user information interface system (UIIS) can be utilized to provide any of information about a user (for example, a patient), referred to as a primary user (PU), an authorized contact (AC), one or more authorized services, any other primary user information, or any combination thereof.

An authorized services user (ASU) with the ability to utilize such a UIIS can quickly and efficiently provide one or more necessary services to the primary user without wasting precious time attempting to identify the primary user and/or an authorized contact. A security setting or profile of a client device (such as a mobile phone) can provide for a bypass when necessary for an ASU to access information about the primary user from the client device, similar to global positioning tracking (GPS) during an emergency services call (such as a 911 call). The ASU or one or more individuals associated with an authorized services can bypass security settings of a client device associated with a primary user so that a near-field communication (NFC) radio can be readily accessed by a client device associated with the ASU. The ASU can then access, for example, information associated with the primary user, such as any of medical information, authorized contact(s), any other emergency information, or any combination thereof. This information can be stored at a UIIS, that includes a network resource or a cloud storage system. The information stored at the UIIS can be altered, changed, deleted, amended, added, or otherwise edited by the primary user and/or any other type of user associated with one or more access parameters that authorize or allow for such actions.

The process can further be streamlined by generating an automated group notification with the one or more authorized contacts, informing them as to a location of the primary user, such as the hospital, room number, and/or telephone number associated with the patient is being taken to as well as a current status. Any type of user can be included in the nurse or receptionist could also be included in this group notification to help answer any questions.

Storing information associated with a primary user in the cloud as part of or accessible by a UIIS provides security, back-up, accessibility features. For example, storing such information locally on a client device, such as a mobile phone, can lead to various issues, such as a user can own or use multiple client devices making it difficult to maintain current information across all client device, information can be become outdated or inaccurate as it is difficult to maintain information across various platforms and/or client devices, a client device can be lost or stolen, information stored on a client device can be intercepted or obtained without permission, any other issue, or any combination thereof. Alternatively, if a primary user can access, edit, or both the information associated with user from the UIIS, the information can be maintained, more efficiently, easily and securely.

Additionally, storing information associated with a primary user at an UIIS, remote from a client device, provides security as information can be prevent from being transmitted unless the information is encrypted. For example, using NFC information can be intercepted by an unintended recipient. One or more aspects of the present disclosure, provides for issuing a temporary personal identification number (PIN) that would be transmitted over NFC that is used to reference or access information at the UIIS associated with the primary user. Any unintended recipient that receives the PIN would not have the credentials to obtain the information associated with the primary user as authentication information (such as a username and/or password) for the UIIS would not have been transmitted with the PIN. As an additional security, the PIN can be a one-time use PIN. Additionally, a quick response (QR) code could be affixed to an associated item of the primary user (for example, a client device, a driver's license, a card, a bracelet, etc.) that could be scanned by the ASU in lieu or in addition to using a NFC. In this way, the process for obtaining information about a primary user is streamlined and secure.

An aspect of the present disclosure provides a user information interface system (UIIS) for providing a user profile to an authorized service. The UIIS comprises a memory storing one or more computer-readable instructions and a processor configured to execute the one or more computer-readable instructions to cause the UIIS to receive an identifier profile request associated with a primary user from an authorized service, determine a user profile associated with the primary user based on the identifier profile request, provide the user profile to the authorized service, and send a status notification to one or more authorized contacts of the user profile.

In an aspect of the present disclosure, the processor is further configured to execute the one or more instructions to further cause the UIS to verify the authorized service based on the user profile.

In an aspect of the present disclosure, the processor is further configured to execute the one or more instructions to further cause the UIIS to compare a security parameter of the identifier profile request to a security information of the user profile, wherein providing the user profile is based on the comparison.

In an aspect of the present disclosure, the security parameter comprises any of a near field communication (NFC) tag, a quick response (QR) code, an image associated with the primary user, or any combination thereof.

In an aspect of the present disclosure, the processor is further configured to execute the one or more instructions to further cause the UIIS to receive an update authorized contacts request from at least one of the one or more authorized contacts, wherein the update authorized contact requests comprises an additional authorized contact, and update the one or more authorized contacts of the user profile based on the additional authorized contact.

In an aspect of the present disclosure, the processor is further configured to execute the one or more instructions to further cause the UIIS to send an additional status update to the updated one or more authorized contacts.

In an aspect of the present disclosure, the processor is further configured to execute the one or more instructions to further cause the UIIS to receive one or more records associated with the primary user from one or more network resource, and send the one or more records to the authorized service.

An aspect of the present disclosure provides a method by a user information interface system (UIIS) to provide a user profile to an authorized service. The method comprises receiving an identifier profile request associated with a primary user from an authorized service, determining a user profile associated with the primary user based on the identifier profile request, providing the user profile to the authorized service, and sending a status notification to one or more authorized contacts of the user profile.

In an aspect of the present disclosure, the method further comprises verifying the authorized service based on the user profile.

In an aspect of the present disclosure, the method further comprises comparing a security parameter of the identifier profile request to a security information of the user profile, wherein providing the user profile is based on the comparison.

In an aspect of the present disclosure, the method further comprises the security parameter comprises any of a near field communication (NFC) tag, a quick response (QR) code, an image associated with the primary user, or any combination thereof.

In an aspect of the present disclosure, the method further comprises receiving an update authorized contacts request from at least one of the one or more authorized contacts, wherein the update authorized contact requests comprises an additional authorized contact, and updating the one or more authorized contacts of the user profile based on the additional authorized contact.

In an aspect of the present disclosure, the method further comprising sending an additional status update to the updated one or more authorized contacts.

In an aspect of the present disclosure, the method further comprises receiving one or more records associated with the primary user from one or more network resources, and sending the one or more records to the authorized service.

An aspect of the present disclosure provides a non-transitory computer-readable medium of UIIS storing one or more instructions for providing a user profile to an authorized service. The one or more instructions when executed by a processor of the UIS, cause the UIIS to perform one or more operations including the steps of the methods described above.

Thus, according to various aspects of the present disclosure described herein, it is possible to provide efficient and secure communication and identification of information associated with a primary user so that one or more authorized services can be effectively administered or provided.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of a network device, according to one or more aspects of the present disclosure;

FIG. 3 illustrates a process for providing a user profile to an authorized service, according to one or more aspects of the present disclosure;

FIG. 4 illustrates a user profile associated with a primary user, according to one or more aspects of the present disclosure;

FIG. 5A illustrates one or more access parameters associated with a type of user associated with a user profile, according to one or more aspects of the present disclosure;

FIG. 5B illustrates a status associated with a user profile, according to one or more aspects of the present disclosure; and

FIG. 6 illustrates a process for providing a user profile to an authorized service provider, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

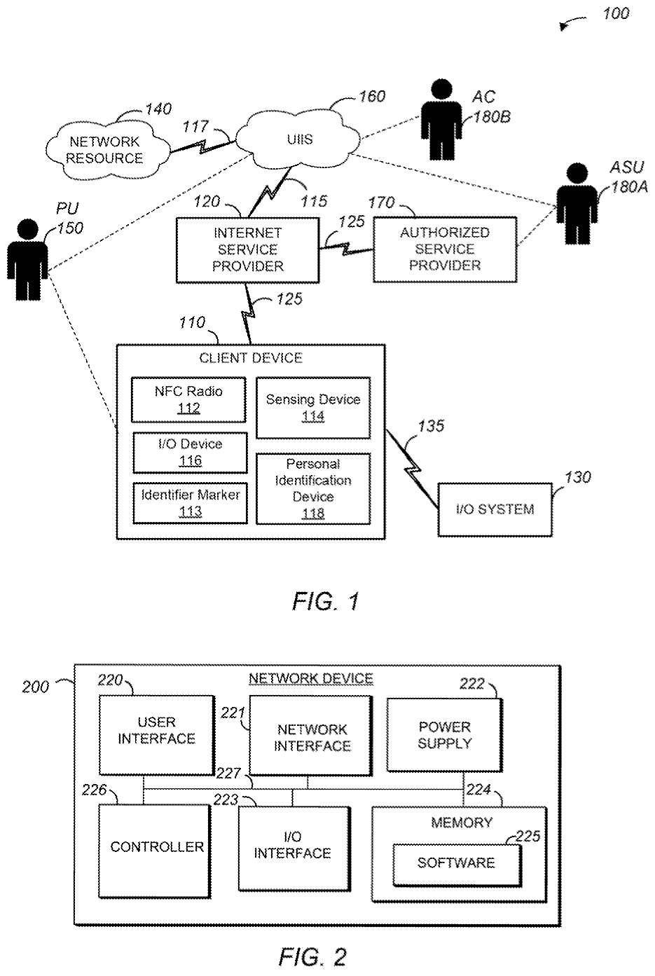

FIG. 1 is a schematic diagram of a network environment 100, according to one or more aspects of the present disclosure. The network environment 100 can comprise any of a network resource 140, a user information interface system (UIIS) 160, an Internet service provider 120, an one or more authorized service provider (ASP) 170, a client device 110, an I/O system 130, one or more users, such as any of one or more types of users 180 (for example, an authorized services user (ASU) 180A, an authorized contact (AC) 180B, or both, collectively referred to as users 180), a primary user (PU) 150, or any combination thereof. For example, the network environment 100 can provide an ASU 180A with information received from a UIIS 160, such as a user profile, associated with a primary user (PU) 150 so as to performed one or more authorized services, provide one or more notifications to an authorized contact 180B, any other one or more services, or any combination thereof.

It should be appreciated that various example embodiments of inventive concepts disclosed herein are not limited to specific numbers or combinations of devices, and there may be one or multiple of some of the aforementioned electronic apparatuses in the network environment, which may itself consist of multiple communication networks and various known or future developed wireless connectivity technologies, protocols, devices, and the like.

One or more connections can connect one or more network devices (such as any of a client device 110, an input/output (I/O) system 130, an Internet service provider (ISP) 120, an authorized service provider 170, a UIIS 160, a network resource 140, or any combination thereof) of the network environment 100. The network environment 100 shown in FIG. 1 includes wired and/or wireless network devices that may be connected in one or more wireless networks (for example, private, guest, iControl, backhaul network, or Internet of things (IoT) network) and/or wired networks within the network environment 100. For example, network resource 140 can be connected to UIIS 160 via a connection 117. UIIS 160 can connect to one or more network devices, such as via a connection 115 to an ISP 120 which connects to a client device 110 and/or an authorized service provider 170 via a connection 125, a connection 117 to a network resource 140, and/or any other network device. The UIIS 160 can also provide information, such as a user profile associated with a PU 150, to one or more users directly or indirectly, wired, or wirelessly, for example, to any of a PU 150, an AC 180B, an ASU, 180A, or any combination thereof.

A UIIS 160 provides and manages information, such as a user profile associated with a primary user 150, for one or more types of users, one or more authorized service providers 170, or both. The UIS 160 can store this information at that UIIS 160, at a network resource 140, or both. The UIIS 160 can manage the information by confirming one or more access parameters associated with a primary user that authorize access to the information. Only those users with authorization are permitted to access the information, such as to edit, alter, create, delete, or otherwise change. The UIIS 160 can also provide the information to an authorized user upon confirmation of the one or more access parameters. An authorized service provider 170 can be associated with one or more authorized services and one or more access parameters of a user profile can indicate that an authorized service provider 170 is permitted to receive information, such as a user profile, associated with the user.

The ISP 120 can be, for example, a content provider or any computer for connecting the UIIS 160 to a network resource 140, such as the Internet. For example, network resource 140 can be a cloud-based service that provides access to a cloud-based repository accessible via ISP 120 where the cloud-based repository comprises information associated with a PU 150, such as a user profile. According to one or more aspects of the present disclosure, the network resource 140 can be any of part of or included with the UIIS 160, local to and/or remote from the UIIS 160, part of a different network or network environment from the UIIS 160, or any combination thereof.

The connection 117 between the network resource 140 and the UIIS 160, the connection 115 between the ISP 120 and the UIIS 160, the connection 125 between the client device 110 and the ISP 120, and the connection 135 between the client device 110 and the I/O system 130 can be implemented using a wired and/or wireless connection, a wide area network (WAN), a virtual private network (VPN), metropolitan area networks (MANs), system area networks (SANs), a data over cable service interface specification (DOCSIS) network, a fiber optics network (for example, FTTH (fiber to the home) or FTTX (fiber to the x), or hybrid fiber-coaxial (HFC)), a digital subscriber line (DSL), a public switched data network (PSDN), a global Telex network, a cellular or mobile network, etc. for example.

In one or more embodiments, the client device 110 can be any type of network device that provides information, such as a user profile associated with the PU 150, and/or access to a UIIS 160. The client device 110 can comprise an NFC radio 112, a sensing device 114, an I/O device 116, a personal identification device 118, an identifier marker 113, any other element or component, or any combination thereof. The NFC radio 112 can provide authorization information to another network device within proximity of the client device 110, for example, a PIN that allows a user associated with one or more access parameters to access a user profile from a UIIS 160. As an example, PIN can be generated by the client device 110, received from a network resource 140, or a combination of the two. The PIN can be a one-time only PIN that is valid for a set time period. In one or more embodiments, the PIN is any of a random number, a timestamp, a user identifier, or any combination thereof. An identifier marker 113 can also be used to provide a type of user associated with one or more access parameters authorization information. For example, the identifier marker 113 can be any type of digital code, such as any of a barcode, a QR code, any other scannable digital marker, or any combination thereof. For example, identifier marker 113 can be scanned by another network device and then used along with login information to access a user profile from a UIIS 160.

The personal identification device 118 can be software, hardware or both that provides a user (associated with one or more access parameters) with a user interface so that the user can access information associated with a primary user 150 to alter, edit change, view, or otherwise access a user profile from a client device 110 associated with the primary user 150, a UIIS 160, any other resource, or any combination thereof. For example, a primary user 150 can use the personal identification device 118 to set up or otherwise configure a user profile at a UIIS 160, an ASU 180A can use the personal identifier device 118 to view or otherwise utilize a user profile provided by a client device 110 associated with a primary user 150 and/or a UIS 160, and/or an authorized contact can use a personal identification device 118 to receive one or more notifications associated with the PU 150 and/or to edit one or more types of users, or any combination thereof. In one or more embodiments, a personal identification device 118 can be or be part of or include within a mobile phone, a set-top box, a laptop, a tablet computer, a notebook computer, any other mobile device or system capable of providing the required access to a user profile associated with a primary user 150, or any combination thereof.

The I/O system 130 and/or the I/O device 116 can comprise any type of device that provides for a user I/O (such as any type of network device), for example, any of an audio/visual output and/or input device, a keyboard, a touchscreen, a multi-media device, a television, a soundbar, a smartphone, an IoT device, a camera, or any combination thereof. The sensing device 114 can provide one or more sensed parameters associated with the associated primary user 150, such as any one or more biometric measurements. The I/O system 130 and/or the I/O device 116 can provide via a user interface data associated with a user, such as a user profile associated with a primary user 150, an interface to a UIIS 160, or both.

FIG. 2 is a more detailed block diagram illustrating various components of an exemplary network device 200, according to one or more aspects of the present disclosure. The network device 200 includes one or more internal components, such as a user interface 220, a network interface 221, a power supply 222, a controller 226, an input/output (I/O) interface 223, a memory 224, and a bus 227 interconnecting the one or more elements.

The power supply 222 supplies power to the one or more internal components of the client device 200 through the internal bus 227. The power supply 222 can be a self-contained power source such as a battery pack with an interface to be powered through an electrical charger connected to an outlet (for example, either directly or by way of another device). The power supply 222 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 220 includes, but is not limited to, push buttons, a keyboard, a keypad, a controller (such as a game controller and/or remote control), a liquid crystal display (LCD), a thin film transistor (TFT), a light-emitting diode (LED), a sensor (such as a motion sensor for detection of any of a gaze, an eye movement, a hand gesture, any other movement of a user, or any combination thereof), a high definition (HD) or other similar display device including a display device having touch screen capabilities so as to allow interaction between a user and the network device 200, for example, the user interface 220 can comprise an I/O device 116. The network interface 220 can include, but is not limited to, various network cards, interfaces, and circuitry implemented in software and/or hardware to enable communications with and/or between another device, such as an ISP 120, a network resource 140, an Y/O system 130, any other device, or any combination thereof.

The memory 224 can be a non-transitory computer readable medium. The memory 224 can include a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical storage system, a hard disk or any other various layers of memory hierarchy. The memory 224 can be used to store any type of instructions, software, or algorithms including software 225, for example, a personal identification device 118.

The controller 226 controls the general operations of the network device 200 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 225 which can include a multi-modal portal application in accordance with one or more embodiments. Communication between the components (for example, 20-25) of the network device 200 may be established using an internal bus 227.

The network interface 221 can include various network cards, interfaces, and circuitry implemented in software and/or hardware to enable communications with any one or more other devices, for example, any of an I/O system 130, ISP 120, any other network device, or any combination thereof. For example, the network interface 221 can include multiple radios or sets of radios (for example, a 2.4 GHz radio, one or more 5 GHz radios, and/or a 6 GHz radio), which may also be referred to as wireless local area network (WLAN) interfaces.

The I/O interface 223 may include various network cards, and circuitry implemented in software and/or hardware to enable communications with a user, for example, via an I/O device 116. The I/O interface 223 can comprise any of a controller (such as a game controller, a remote control, etc.), a button, a sensor, a speaker, a microphone, any other I/O interface, or any combination thereof.

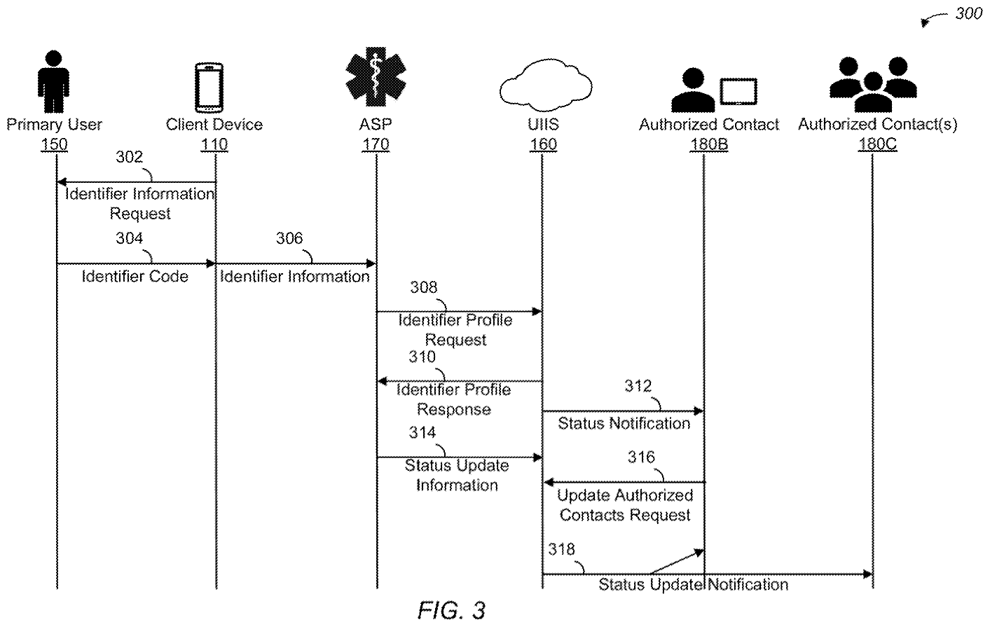

FIG. 3 illustrates UIIS environment 300, according to one or more aspects of the present disclosure. The UIS environment 300 comprises a primary user 150, such as any of a patient, an aging-in-place individual, assisted-living resident, any other individual requiring one or more authorized services, or any combination thereof, associated with a client device 110, an authorized services provider 170, a UIIS 160, an authorized contact 180B, and one or more other authorized Contacts 180C.

A client device 110 can provide an identifier information request 302 to a primary user 150. For example, the identifier information request 302 can request from a primary user 150 that an authorized service provider 170, any other authorized user, or both be permitted to access a user profile associated with the primary user 150. The primary user 150 can provide identifier code 304 to the client device 110. In one or more embodiments, providing the identifier information can comprise any of the primary user 150 can enter a password, PIN, or other identifier code, a scan can be performed, such as a facial recognition scan, a fingerprint scan, or both, a user input can be entered, such as via a user interface, any other approval/disapproval validation, or any combination thereof. The client device 110 can provide the identifier information 306 to the authorized service provider 170, for example, the identifier information 306 can comprise any of the identifier code 304, any other data associated with the primary user 150, or both. In one or more embodiments, the client device 110 is a network device associated with an authorized services personnel of the authorized service provider 170 such that the identifier code 304 is any of a facial or fingerprint recognition that provides the identifier information 306, a QR code scan, a barcode scan, any other scan, or any combination thereof. In one or more embodiments, an identifier code, such as a PIN or a QR code, can be affixed to any of a client device 110 associated with a primary user 150, any object associated with the primary user 150 (such as an identifier bracelet, a card, any other object, or any combination thereof), any other device, or any combination thereof such that an authorized services personnel can enter the identifier code at a client device 110 associated with the authorized services personnel.

The authorized service provider 170, can receive the identifier information 306, from an authorized services personnel, a primary user 150, any other user with the identifier information, or any combination thereof, and send an identifier profile request 308 to a UIS 160. The identifier profile request 308 can comprise the identifier information 306, a requestor identifier (such as a username, user password, or both), a status information associated with the primary user 150, any other data required for authentication and/or authorization, or any combination thereof. The UIIS 160 can determine an authorization to access the information associated with the primary user 150 based on the identifier profile request 308. For example, the UltS 160 can determine that a user profile is associated with the primary user 150 based on the identifier profile request 308. The user profile can comprise one or more access parameters that indicate that the requestor identifier is a type of user that is authorized to receive the requested user profile. The UIIS 160 can send an identifier profile response 310 to the authorized service provider 170 in response to the identifier profile request 308. The identifier profile response 310 can comprise the user profile associated with the primary user 150 based on the identifier profile request. In one or more embodiments, the UIIS 160 can send all or part of the data associated with the user profile based on one or more access parameters associated with the user profile.

The UIIS 160 can send a status notification 312 to an authorized contact 180 based one or more access parameters associated with the user profile. The status notification 312 can comprise status information received as part of the identifier profile request 308. The UIIS 160 can receive periodically, in real-time, upon request, at any other interval, or any combination thereof, one or more status update information 314 that comprises an updated to a status associated with the primary user 150, for example, a status 520 as discussed with reference to FIG. 5B. For example, the primary user 150 can be transported to an emergency room or other facility and this status update information can be sent to the UIIS 150 to update the status 520 of the user profile 450. The status update information 314 can comprise the same or similar information as in the status notification 312 but can also comprise any of an update to a location of the primary user 150, identify one or more attending persons (such as a particular healthcare professional or attendant), provide a current status as to one or more biometric data, any other update, or any combination thereof.

At any time, the authorized contact 180B can send an update authorized contacts request 316 to the UIIS 160 to update the authorized contacts associated with the user profile. For example, an authorized contact 180B can be associated with one or more access parameters that allow the authorized contact 180B to update the list of authorized contacts that receive a status notification associated with the primary user 150. For example, the UIIS 160 can verify that the authorized contact 180B is associated with one or more access parameters that allow the authorized contact 180B to make a change to the authorized contacts that should receive notifications. The UIIS 180B can then send the received status update information 314 as a stat update notification 318 to the authorized contact 180B and one or more other authorized contacts 180C as updated by the authorized contact 180B. In this way, one or more authorized contacts 180 are provided by the UIIS 160 with a status notification 312/status update notification 318.

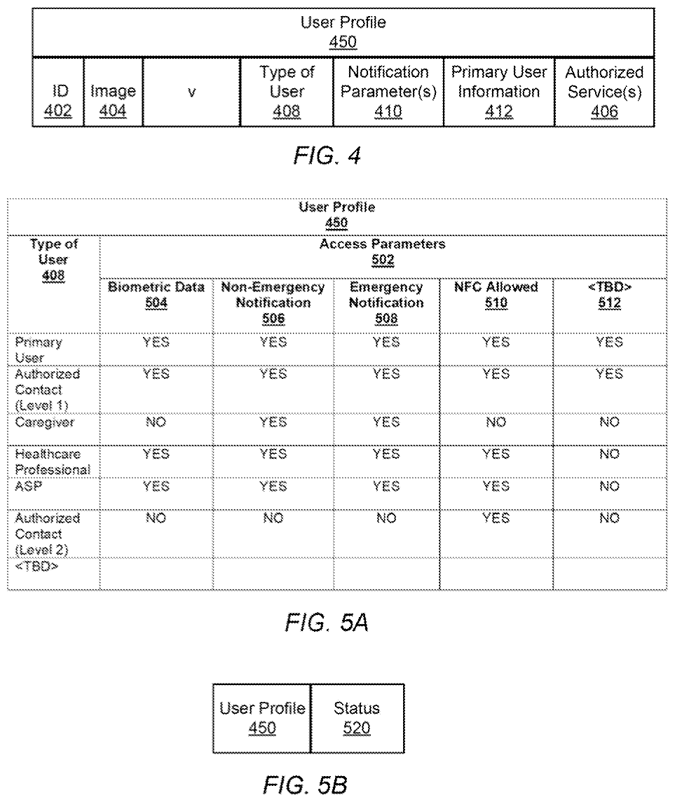

While FIG. 3 illustrates an update or status provided by an ASP 170, the present disclosure contemplates that any type of user (for example, as discussed with reference to FIG. 4) can provide an update or status to the UIIS 160, for example, as discussed with reference to client device 110 of FIG. 1. In this way, all types of user associated with a primary user 150 can provide an update or status to the UIIS 160 so that any authorized contact can be notified based on the user profile associated with the primary user 150.

FIG. 4 illustrates a user profile 450 associated with a primary user 150, according to one or more aspects of the present disclosure. The user profile 450 can comprise any of an identifier 402, an image 404, a security information 406, a type of user 408, one or more notification parameters 410, a primary user information 412, one or more authorized services 406, or any combination thereof. The identifier (ID) 402 can comprise a unique identifier associated with a primary user 150. The identifier 402 can distinguish a first primary user 150 from a different second primary user 150.

The image 404 can be an image associated with a facial aspect of the primary user 150, a fingerprint associated with the primary user 150, a scan of any feature associated with the primary user, any other image associated with the primary user 150, or any combination thereof. For example, the UIIS 160 can receive an identifier profile request 308 from an authorized service provider 170 (such as from a authorized services personnel or a network device associated with the authorized services personnel) that comprise data associated with a facial recognition scan and/or a fingerprint of the primary user 150 and compare the image 404 to the data received so as to determine the user profile 450 associated with the primary user 150.

The security information 406 can comprise any data that indicates a security code associated with the user profile 450. For example, the security information 406, can comprise any of a username, a user password, a PIN, any other data based on an identifier marker 113, or any combination thereof. As an example, the UIIS 160 can require a login to the UIIS 160 (for example, using a username and/or password) and then also require security information 406 before allowing access to a user profile 450.

A type of user 408 indicates one or more users associated with a particular user profile 450 and one or more access parameters as discussed with reference to FIG. 5A. The types of user can comprise an authorized services personnel associated with one or more authorized services 406, one or more authorized contacts, a primary user, one or more other users, or any combination thereof. For example, one or more authorized services 406 can comprise one or more emergency medical services, such as an ambulance service, a physical service, a hospital service, an emergency response service, any other medical service, or any combination thereof, a caregiver service, such as at an assisted living center, an aging-in-place facility or environment, in-home service, any other caregiver service, or any combination thereof, any other service associated with a primary user 150, or any combination thereof.

The one or more notification parameters 410 can comprise a type of notification that is to be sent to any one or more type of users 408 (such as a text message, a telephone call, an electronic mail message, any other type of message, or any combination thereof), a timestamp, a frequency, type of data to be included in a notification based on the type of user and/or primary use information 412, any other notification parameter, or any combination thereof.

The primary user information 412 can comprise any information associated with a primary user 150. For example, the primary user information 412 can comprise one or more medications, one or more healthcare professional (such as any of a physician, a nurse, nurse practitioner, any other healthcare professional, or any combination thereof), one or more medical conditions, age, weight, height, any one or more biometric parameters, an address, a telephone number, one or more links to a portal hosted or provided by one or more other authorized service providers 170 and/or other entity (such as a patient portal at a medical facility), any other information associated with a primary user 150, or any combination thereof.

FIG. 5A illustrates one or more access parameters 502 associated with a type of user 408 associated with a user profile 450, according to one or more aspects of the present disclosure. In one or more embodiments, a user profile 450 can comprise a type of user 408 that is associated with one or more access parameters 502. For example, a user profile 450 can be accessed by a primary user, an authorized contact (level 1), a caregiver, a healthcare professional, and an ASP, an authorized contact (level 2). While only certain types of users are listed in FIG. 5A, the present disclosure contemplates that any other type of user to be determined (TBD) can be associated with a user profile 450 and one or more access parameters 502. For example, the one or more access parameters 502 can comprise any of biometric data 504 (for example, a YES indicates that the type of user 408 receives biometric data and a NO indicates that the type of user 408 does not receive biometric data), non-emergency notification 506 (for example, a YES indicates that the type of user 408 receives non-emergency notifications and a NO indicates that the type of user 408 does not receive non-emergency notifications), emergency notification 508 (for example, a YES indicates that the type of user 408 receives emergency notifications and a NO indicate that the type of user 408 does not receive emergency notifications), an NFC allowed 510 (for example, a YES indicates that the type of user 408 receives authorization information and a NO indicates that the type of user 408 does not receive authorization information where the authorization information can comprise a PIN), any other parameters (indicated by TBD 512), or any combination thereof.

FIG. 5B illustrates a status 520 associated with a user profile 450, according to one or more aspects of the present disclosure. The status 520 can comprise status update information associated with a primary user 150. For example, a status notification 312 to an authorized contact 180B can comprise a status 520 of the primary user 150. The status 520 can be updated any of in real-time (such as by an authorized services user 180A, periodically (such as each time a measurement is received from a sensing device), at any other interval, or any combination thereof. For example, an authorized service provider 170 can update the status 520 based on information received from an authorized services user 180A.

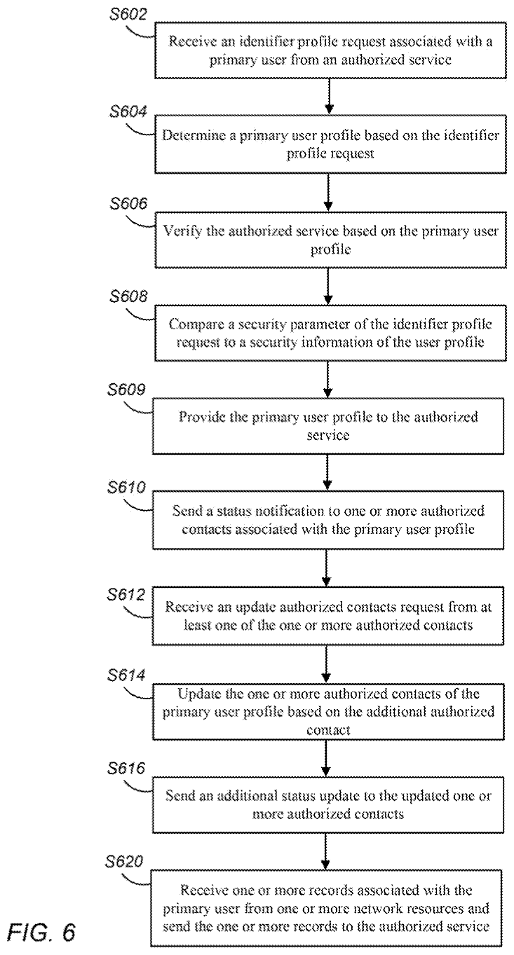

FIG. 6 illustrates a process for providing a user profile 450 to an authorized service provider 170, according to one or more aspects of the present disclosure. A UIIS 160 may be programmed with one or more instructions that when executed by a processor or controller causes the UIIS 160 to provide a user profile 450 to an authorized service provider 170. In FIG. 6, it is assumed that the UIIS 160 includes a respective controller and a respective software stored in a respective memory, as discussed above in connection with FIGS. 1-2, which when executed by the respective controller performs the functions and operations in accordance with the example embodiments of the present disclosure.

The UIIS 160 comprises a controller 226 that executes one or more computer-readable instructions, stored on a memory 224, that when executed perform one or more of the operations of steps S602-S620. The UIIS 160 can comprise software, such as one or more software 25, hardware, such as one or more components of network device 200, or both. While the steps S602-S620 are presented in a certain order, the present disclosure contemplates that any one or more steps can be performed simultaneously, substantially simultaneously, repeatedly, in any order or not at all (omitted).

At step S602, UIIS 160 receives an identifier profile request associated with a primary user from an authorized service. For example, an authorized services personnel can be associated with an authorized service. As an example, a paramedic can be dispatched to a scene where a primary user is not able to provide personal information. The paramedic can utilize the UIIS 160 by sending the UIIS 160 an identifier profile request so that the paramedic can obtain personal information about the primary user even when the primary user is not able to respond.

At step S604, the UIIS 160 determines a user profile associated with the primary user based on the identifier profile request. A user profile can be previously stored at the UIIS 160 and/or a repository associated with the UIIS 160, such as a network resource 140. The network resource 140 and/or the repository can comprise an electronic health record system that stores information associated with a primary user from any of one or more authorized services providers, a medical provider, any other national and/or international source of information, or any combination thereof.

At step S606, the UIIS 160 verifies the authorized service based on the user profile determined at step S604. For example, the authorized service 406 of a user profile 450 can be compared to information provided with the identifier profile request 308 to determine that the authorized service is authorized to receive the user profile 450 and/or one or more access parameters 502 associated with the user profile 450.

At step S608, the UIIS 160 compares a security parameter of the identifier profile request to a security information of the user profile. For example, the paramedic at the scene can obtain a PIN using NFC by placing a network device 200 associated with the paramedic at or near the client device 110 of the primary user. This PIN can be sent along with or as part of the identifier profile request so as to obtain the user profile associated with the primary user.

At step S609, the UIIS 160, provides the user profile to the authorized service, for example, an authorized services personnel. For example, once the authorized service associated with the paramedic is verified, the paramedic can receive the user profile associated with the primary user so as to ascertain critical information, such as an identity, one or more medical conditions associated with eh primary user, or both.

At step S610, the UIIS 160 sends a status notification to one or more authorized contacts associated with the user profile. The status notification can provide a status, such as a status 520, associated with the primary user to the one or mor authorized contacts. For example, once the paramedic has access to the user profile associated with the primary user, the paramedic can provide updates to an emergency health system or other repository/network resource and in so doing automatically update one or more authorized contacts of the user profile associated with the primary user.

At step S612, the UIIS 160 receives an update authorized contacts request from at least one of the one or more authorized contacts and at step S614 updates the one or more authorized contacts of the user profile based on the additional authorized contact. For example, an authorized contact can determine that others need to be provided updates to the status of the primary user and can request an update to one or more other authorized contacts so that these one or more other authorized contacts can receive automatic updates with the authorized contact continuously having to forward or send the status. Once updates, the UIIS 160 at step S616 can send an additional status update to the updated one or more authorized contacts.

At step S620, the UIIS 160 receives one or more records associated with the primary user from one or more network resources and sends the one or more records to the authorized service, for example, to an authorized services personnel. For example, the one or more records can comprise information associated with the primary user from an emergency health system, other medical provider, authorized service provider, any other network resource, or any combination thereof. As an example, the paramedic can receive one or more records that indicate a blood type, a medical condition, any other information associated with the primary user, or any combination.

According to one or more example embodiments of inventive concepts disclosed herein, there are provided novel solutions for providing a user profile to one or more users and/or an authorized service provider without requiring a primary user to initiate or provide authorization.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a” “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A user information interface system (UIIS) for providing a user profile to an authorized service comprising:
a memory; and
a processor configured to execute one or more instructions stored on the memory to cause the UIIS to:
receive an identifier profile request associated with a primary user from an authorized service;
determine the user profile associated with the primary user based on the identifier profile request;
provide the user profile to the authorized service; and
send a status notification to one or more authorized contacts of the user profile.

2. The UIIS of claim 1, wherein the processor is further configured to execute the one or more instructions to further cause the UIIS to:
verify the authorized service based on the user profile.

3. The UIIS of claim 1, wherein the processor is further configured to execute the one or more instructions to further cause the UIIS to:
compare a security parameter of the identifier profile request to a security information of the user profile, wherein providing the user profile is based on the comparison.

4. The UIIS of claim 3, wherein the security parameter comprises any of a near field communication (NFC) tag, a quick response (QR) code, an image associated with the primary user, or any combination thereof.

5. The UIIS of claim 1, wherein the processor is further configured to execute the one or more instructions to further cause the UIIS to:
receive an update authorized contacts request from at least one of the one or more authorized contacts, wherein the update authorized contact requests comprises an additional authorized contact; and
update the one or more authorized contacts of the user profile based on the additional authorized contact.

6. The UIIS of claim 5, wherein the processor is further configured to execute the one or more instructions to further cause the client device to:
send an additional status update to the updated one or more authorized contacts.

7. The UIIS of claim 1, wherein the processor is further configured to execute the one or more instructions to further cause the client device to:
receive one or more records associated with the primary user from one or more network resources; and
send the one or more records to the authorized service.

8. A method by a user information interface system (UIIS) to provide a user profile to an authorized service, the method comprising:
receiving an identifier profile request associated with a primary user from an authorized service;
determining a user profile associated with the primary user based on the identifier profile request;
providing the user profile to the authorized service; and
sending a status notification to one or more authorized contacts of the user profile.

9. The method of claim 8, further comprising:
verifying the authorized service based on the user profile.

10. The method of claim 8, further comprising:
comparing a security parameter of the identifier profile request to a security information of the user profile, wherein providing the user profile is based on the comparison.

11. The method of claim 10, wherein the security parameter comprises any of a near field communication (NFC) tag, a quick response (QR) code, an image associated with the primary user, or any combination thereof.

12. The method of claim 8, further comprising:
receiving an update authorized contacts request from at least one of the one or more authorized contacts, wherein the update authorized contact requests comprises an additional authorized contact; and
updating the one or more authorized contacts of the user profile based on the additional authorized contact.

13. The method of claim 12, further comprising:
sending an additional status update to the updated one or more authorized contacts.

14. The method of claim 8, further comprising:
receiving one or more records associated with the primary user from one or more network resources; and
sending the one or more records to the authorized service.

15. A non-transitory, computer-readable medium of a user identifier interface system (UIIS) storing one or more computer-readable instructions for sending a user profile to an authorized service that when executed by a processor, cause the UIIS to perform one or more operations comprising:
receiving an identifier profile request associated with a primary user from an authorized service;
determining a user profile associated with primary user based on the identifier profile request;
providing the user profile to the authorized service; and
sending a status notification to one or more authorized contacts of the user profile.

16. The non-transitory, computer-readable medium of claim 15, wherein the one or more computer-readable instructions when executed by the processor, further cause the processor to perform the one or more operations further comprising at least one of:
verifying the authorized service based on the user profile; and
comparing a security parameter of the identifier profile request to a security information of the user profile, wherein providing the user profile is based on the comparison.

17. The non-transitory, computer-readable medium of claim 16, wherein the security parameter comprises any of a near field communication (NFC) tag, a quick response (QR) code, an image associated with the primary user, or any combination thereof.

18. The non-transitory, computer-readable media of claim 15, wherein the one or more computer-readable instructions when executed by the processor, further cause the processor to perform the one or more operations further comprising:
receiving an update authorized contacts request from at least one of the one or more authorized contacts, wherein the update authorized contact requests comprises an additional authorized contact; and
updating the one or more authorized contacts of the user profile based on the additional authorized contact.

19. The non-transitory computer-readable media of claim 18, wherein the one or more computer-readable instructions when executed by the processor, further cause the processor to perform the one or more operations further comprising:
sending an additional status update to the updated one or more authorized contacts.

20. The non-transitory computer-readable media of claim 15, wherein the one or more computer-readable instructions when executed by the processor, further cause the processor to perform the one or more operations further comprising:
receiving one or more records associated with the primary user from one or more network resources; and
sending the one or more records to the authorized service.
